(19) United States
(12) Patent Application Publication
(10) Pub. No.: US 2006/0278317 A1
(43) Pub. Date: Dec. 14, 2006

(54) Bead structure of a tire

(76) Inventor: Vincent Cheng, Changhua City (TW)

Correspondence Address: CHARLES E. BAXLEY, ESQ., 90 JOHN STREET, THIRD FLOOR, NEW YORK, NY, 10038, US

(21) Appl. No.: 11/484,536

(22) Filed: Jul. 11, 2006

Related U.S. Application Data
(63) Continuation-in-part of application No. 11/151,049, filed on Jun. 13, 2005.

(51) Int. Cl. B60C 3/08

(52) U.S. Cl. 152/457; 152/540

(57) ABSTRACT

A bead of a tire comprises a pair of beads interiorly inserted with a plurality of annular members, and the annular members are mutually parallel. Each of the annular members is made of a plurality of flexible steel cords twisted together, and the diameter of the respective flexible steel cords ranging from 0.05 mm to 1.0 mm. The tire is flexible and can be folded/rolled into a compact package for easy transportation and storage. In addition, a reinforcing member is made of cotton or other materials and can be rounded with the annular member for improving the joint strength of the flexible steel cords.

This application is a Continuation-in-Part of U.S. patent application Ser. No. 11/151,049, filed Jun. 13, 2005, to which application priority is claimed.

### BACKGROUND OF THE INVENTION

1. Field of the Invention

The present invention relates to a tire, and more particularly to a bead structure of a tire for fitting to a rim of wheel of a bike or a motorbike.

2. Description of the Prior Arts

Referring to FIG. 1, a conventional tire 11 generally includes a pair of axially spaced apart beads 12 inserted with a plurality of rigid steel wires 13. When the tire 11 is inflated, the beads 12 will press firmly against the inner edge of a wheel.

The rigid steel wires 13 should be reinforced in order to make the beads 12 of the tire 11 annular shaped, enabling the tire 11 to withstand pressure and to press firmly against the inner edge of the wheel 14. That's why the conventional tire 11 must be inserted with the steel cords 13 that are gathered together and located in the center of the beads 12.

The reinforced steel wires 13 make the tire 11 annular-shaped but also makes it more resistant to deformation, so that the tires 11 only can be stacked on top of one another or side by side, and this stacking manner takes up too much spaces, and is inconvenient for transportation.

The present invention has arisen to mitigate and/or obviate the afore-described disadvantages.

### SUMMARY OF THE INVENTION

The primary objective of the present invention is to provide a bead structure of a tire, that can be folded/rolled into a compact package for easy transportation and storage.

A bead structure comprises a pair of bead portions interiorly inserted with a plurality of annular members; each of the annular members is made of a plurality of flexible steel cords twisted together, and the annular members are mutually parallel. In addition, the diameter of the respective flexible steel cords ranging from 0.05 mm to 1.0 mm. According the afore-described, the tire is flexible, and the annular members are not damaged when the tire is folded/rolled into a compact package, so that the tire is easily transported and stored at suitable place.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of showing a conventional tire structure;

FIG. 2 is a cross sectional view of showing a tire in accordance with a first embodiment of the present invention;

FIG. 3 is an enlarged view of showing an annular member in accordance with a first embodiment of the present invention;

FIG. 4 is an enlarged cross sectional view of a part of the bead of the tire in accordance with a second embodiment of the present invention;

FIG. 5 is an enlarged cross sectional view of a part of the bead of the tire in accordance with a third embodiment of the present invention;

FIG. 6 is an enlarged cross sectional view of a part of the bead of the tire in accordance with a fourth embodiment of the present invention;

FIG. 7 is an enlarged cross sectional view of a part of the bead of the tire in accordance with a second embodiment of the present invention;

FIG. 8 is an enlarged view of showing an annular member wound with a reinforcing member in accordance with another embodiment of the present invention;

FIG. 9 is a perspective view of an annular member in accordance with the present invention;

FIG. 10A is a perspective of showing a banding shape tire in accordance with the present invention;

FIG. 10B is a cross section view of showing a package tire in accordance with the present invention;

FIG. 10C is a cross section view of showing a package tire in accordance with the present invention;

FIG. 11A is a perspective view of showing a tire for a bicycle in accordance with the present invention; and

FIG. 11B is a perspective view of showing a tire for a motorcycle in accordance with the present invention.

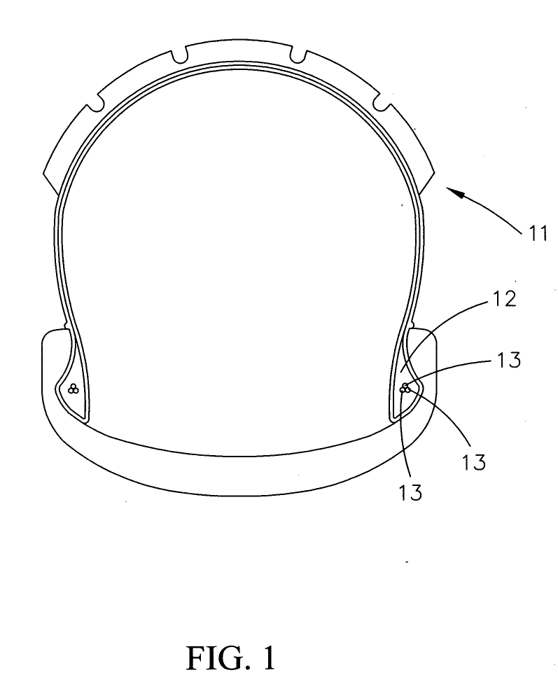

### DETAILED DESCRIPTION OF THE PREFERRED EMBODIMENTS

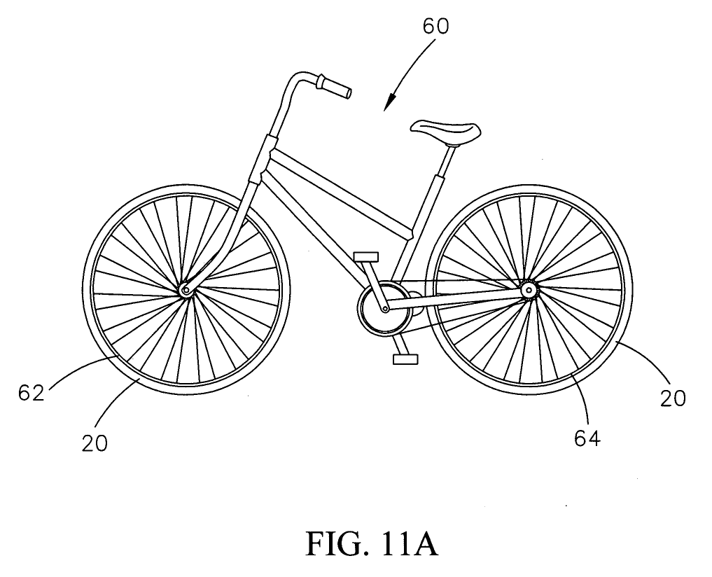

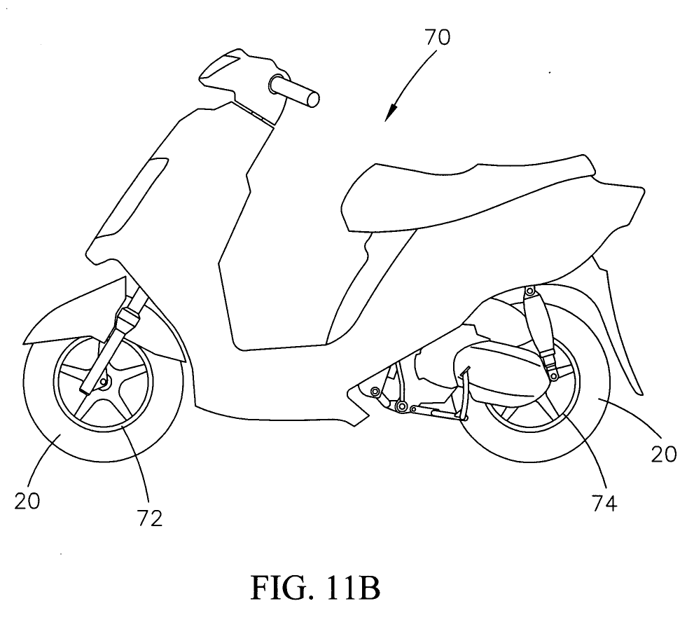

Referring to FIG. 11A and FIG. 11B, a bicycle 60 and a motorcycle 70, a front rim 62, 72 and rear rim 64,74 are fitted a tire 20 respectively.

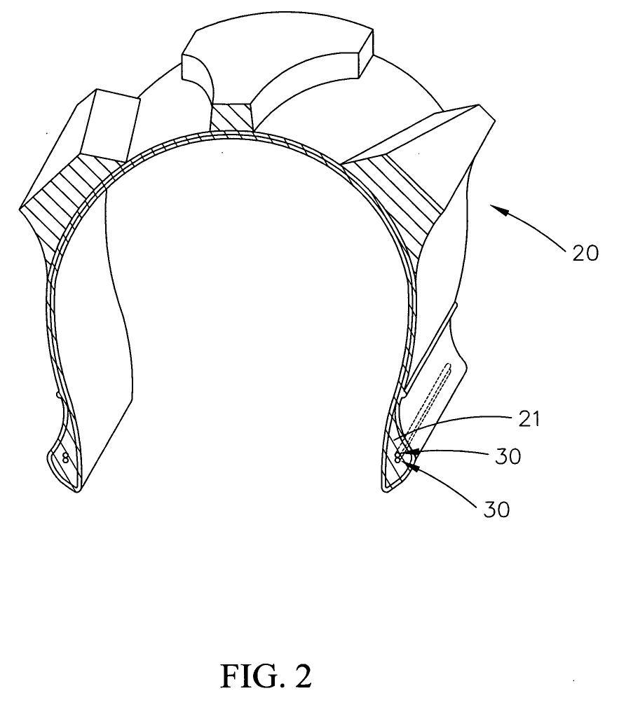

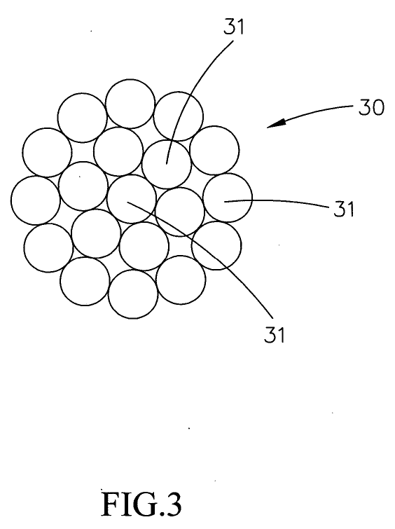

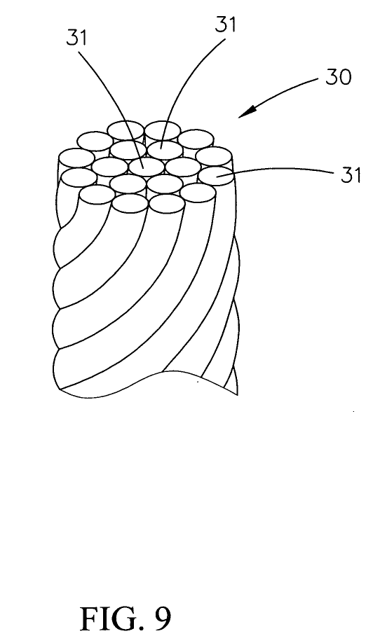

Referring to FIGS. 2, 3 and 9, a tire 20 in accordance with the present invention is shown and comprises a pair of beads 21 interiorly inserted with a plurality of annular member 30.

Each of the annular members 30 is made of a plurality of flexible steel cords 31 twisted together, and the annular members 30 are mutually parallel. The flexible steel cords 31 have a diameter ranging from 0.05 mm to 1.0 mm, preferably 0.1˜0.5 mm. The annular members 30 made of flexible steel cords 31 also can make the beads 21 of the tire 20 annular shaped, and enable the beads press firmly against the inner edge of the wheel (not shown) when the tire is inflated.

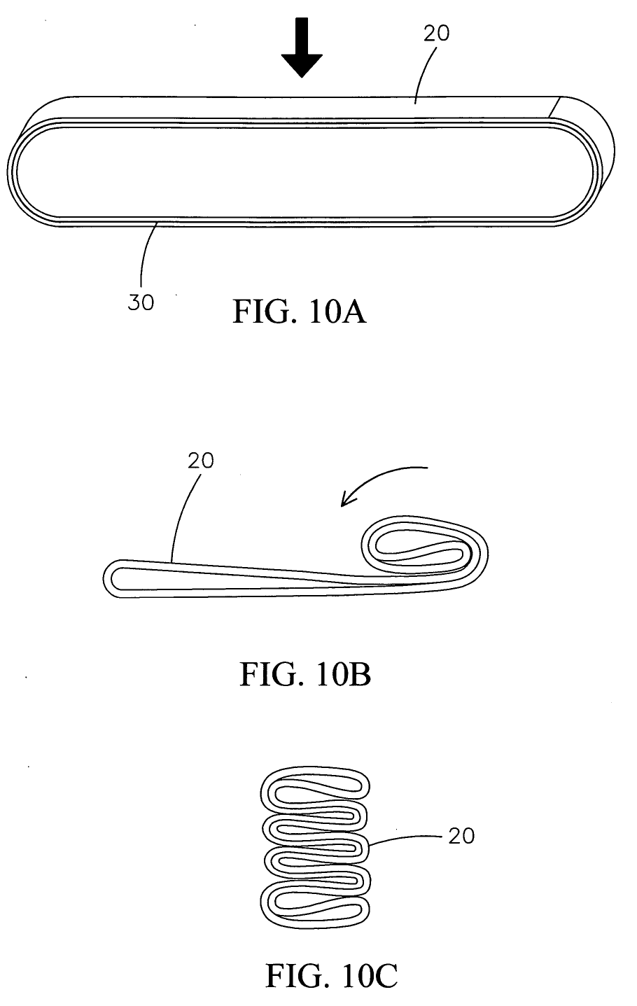

Referring to FIG. 10A, the flexible steel cords make the annular members 30 pretty flexible and tough, so that the tire 20 can be pressed to form a banding shape. Referring to FIG. 10B and FIG. 10C, the banding tire 20 can be folded or rolled into a compact package for easy transportation and storage, thus substantially saving the transportation cost.

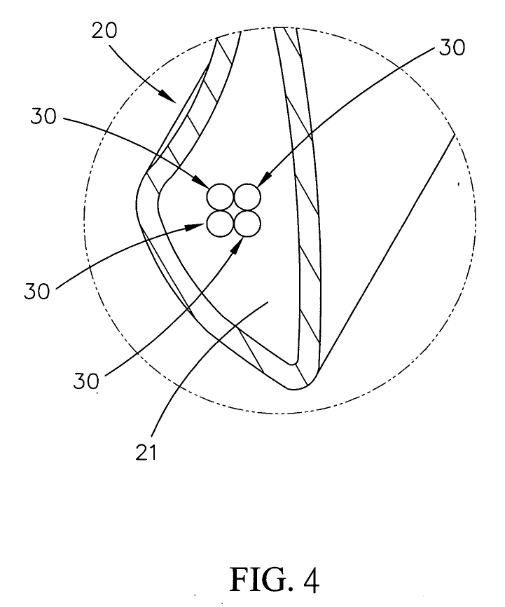

Referring to FIG. 4, which shows four annular members 30, and the annular members 30 are mutually parallel and arranged squarely in cross section.

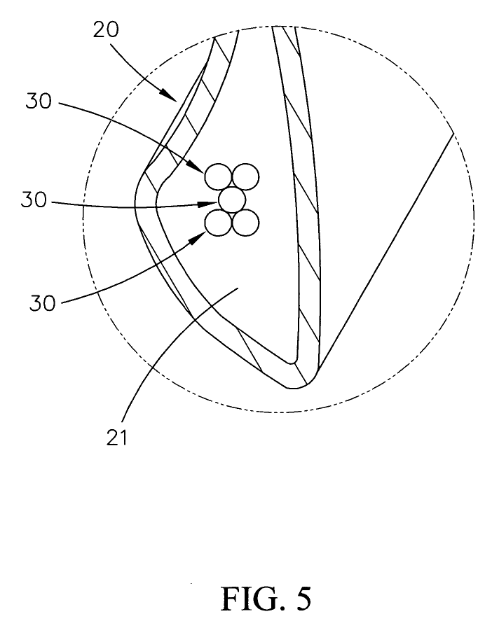

FIG. 5 shows that five annular members 30 are mutually parallel.

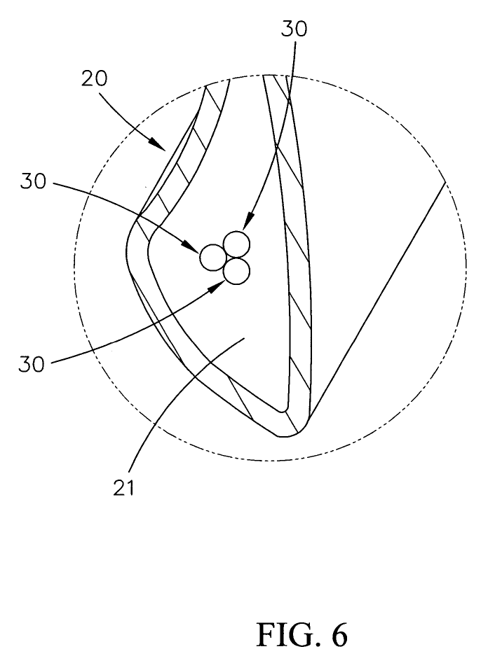

FIG. 6 shows that three annular members 30 are arranged in a triangle and mutually parallel.

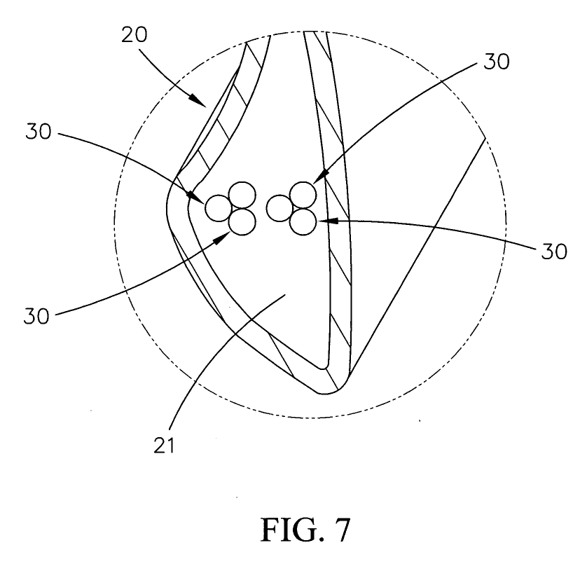

FIG. 7 shows two member groups 50. Each group 50 includes three annular members 30 are arranged in a triangle and mutually parallel.

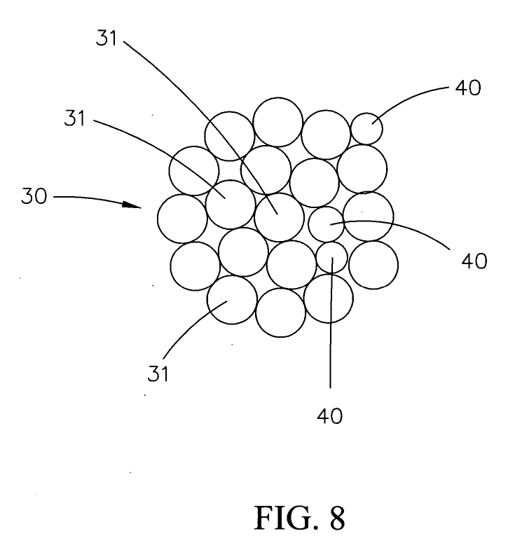

Referring to FIG. 8, at least one of reinforcing member 40 is twisted with the annular member 30 in order to improve the strength therein. The reinforcing member(s) 40 can be winds around the outmost surface of the annular member 30, or the reinforcing member(s) 40 can be twisted inside the annular member 30. The reinforcing member 40 ranges 0.05˜1.0 mm in diameter and can be made of cotton yarns, flexible steel cords, synthetic cord or plastic cord.

The afore-described, the diameter of the reinforcing member 40 is smaller than the diameter of the flexible steel cord 31. Further, the diameter of the reinforcing member 40 is larger than or equal to the diameter of the flexible steel cord 31.

It is to be noted that each of the annular members 30 is made of flexible steel cords 31, and the number of the flexible steel cords 31 preferably ranges from 2 to 19.

While we have shown and described various embodiments in accordance with the present invention, it should be clear to those skilled in the art that further embodiments may be made without departing from the scope of the present invention.

What is claimed is:

1. A bead structure of a tire for fitting to a rim of a wheel of a vehicle, said beads structure comprising:
two bead portions formed at opposite sidewall; and
a plurality of annular members are mutually parallel and inserted into each bead portion, and each annular member formed with a plurality of flexible steel cords twist together;
wherein the pair of bead portions can be wildly opened, and the tire can be pressed to form a banding structure, so that the tire can be rolled or folded into a package.

2. The bead structure of a tire as claimed in claim 1, further comprising a reinforcing member, the reinforce member is twisted with the flexible steel cords.

3. The bead structure of a tire as claimed in claim 1, wherein the vehicle is a bicycle.

4. The bead structure of a tire as claimed in claim 1, wherein the vehicle is a motorcycle.

5. The bead structure of a tire as claimed in claim 1, wherein each of the bead portions interiorly inserted two annular members.

6. The bead structure of a tire as claimed in claim 1, wherein each of the bead portions interiorly inserted three annular members.

7. The bead structure of a tire as claimed in claim 1, wherein each of the bead portions interiorly inserted four annular members.

8. The bead structure of a tire as claimed in claim 1, wherein each of the bead portions interiorly inserted five annular members.

9. The bead structure of a tire as claimed in claim 2, wherein the reinforcing member is a cotton yarn.

10. The bead structure of a tire as claimed in claim 2, wherein the reinforcing member is a flexible steel cord.

11. The bead structure of a tire as claimed in claim 2, wherein the reinforcing member is a plastic cord.
